(19) United States
(12) Patent Application Publication
(10) Pub. No.: US 2016/0177140 A1
(43) Pub. Date: Jun. 23, 2016

(54) TIRE HAVING COFFEE GRAINS

(71) Applicant: Federal Corporation, Taoyuan (TW)

(72) Inventor: JUNG-CHIN CHIANG, Taoyuan (TW)

(21) Appl. No.: 14/963,301

(22) Filed: Dec. 9, 2015

(30) Foreign Application Priority Data
Dec. 22, 2014 (TW) 103144764

(51) Int. Cl. C09J 11/06; C09J 9/00; C09J 119/00; B32B 25/02; B60C 1/00

(52) U.S. Cl. CPC C09J 11/06; B32B 25/02; B60C 1/00; C09J 119/003; C09J 9/00; B32B 2605/00; B32B 2307/758; B32B 2264/06

(57) ABSTRACT

A tire having coffee grains of the present invention includes a tire adhesive layer, which is a solid-state colloid at least formed by raw rubber. The solid-state colloid is disposed with a plurality of coffee particles, and each of the coffee particles is a structure having multiple micro gaps. Under a condition of maintaining the structural strength unaffected, the coffee particles having the micro gaps and mainly consisted of a hydrocarbon are capable of eliminating odor of the tire adhesive layer. Thus, using more aggressive and reliable means, the present invention alleviates the odor of conventional tires and the resultant discomfort as well as possible toxic reactions.

### BACKGROUND OF THE INVENTION

a) Field of the Invention

The invention relates in general to a tire, and more particularly to a tire having coffee grains capable of effectively eliminating odor of a tire adhesive layer.

b) Description of the Prior Art

As generally known, tires, a primary medium between a vehicle on wheels and the ground, drive the entire vehicle on wheels for forward and backward movements through rolling means, and buffer the impact from the ground using a plastic material to enhance comfort in the riding process. A common tire, from the inside to the outside, essentially at least includes at least one support layer, at least one buffer layer and a tire adhesive layer.

In principle, the tire adhesive layer of a tire is formed by mixing and hardening raw rubber, a reinforcing agent, a vulcanizing agent, an anti-aging agent, and a filler agent. A conventional tire adhesive layer is usually made of natural rubber. Although providing better wear resistance and elasticity, natural rubber can be obtained in a less quantity and is prone to aging and hence deterioration. Thus, natural rubber is gradually replaced by synthetic rubber, e.g., styrene-butadiene rubber (SBR) and butadiene rubber (BR).

However, regardless whether natural rubber or synthetic rubber is adopted as the primary material with tire adhesive layer, after processing and hardening for formation, certain rancid odor of protein from natural rubber or pungent smell of residual monomers from synthetic rubber as well as odor similar to rotten eggs from sulfur-containing substances such as processing oils and vulcanizing agents are formed. Such disagreeable odor or smell may cause people discomfort. For higher-priced products, consumers may question the quality of these products as a result of such repugnant odor.

### SUMMARY OF THE INVENTION

In view of the above, it is a primary object of the present invention to provide a tire having coffee grains capable of effectively eliminating odor of a tire adhesive layer.

To achieve the above object, the present invention provides a tire having coffee grains at least including a solid-state tire adhesive layer. The tire adhesive layer is formed from mixing and hardening components of: raw rubber, having a weight percentage between 35% and 60%; a reinforcing agent, having a weight percentage between 25% and 50%; a vulcanizing agent, having a weight percentage between 0.5% and 3%; an anti-aging agent, having a weight percentage between 1% and 5%; and a plurality of coffee particles, each being a grain having a diameter between 0.5 mm and 1.0 mm, a weight percentage of all of the coffee particles being between 1% and 10%.

By the above technical features, the tire having coffee grains, under the condition of maintaining the structural strength unaffected, eliminates the odor of the tire adhesive layer using the coffee particles having multiple micro gaps and mainly consisted of a hydrocarbon. Therefore, the present invention, using more aggressive and reliable means, alleviates the odor of conventional tires and the resultant discomfort as well as possible toxic reactions.

According to the above technical features, the tire adhesive layer is formed by mixing and hardening under operating conditions of an environment having a pressure of 19 Kg to 21 Kg, and a heating temperature of 170° C. to 183° C. for a heating period of 10 to 13 minutes.

In the above technical features, the tire having coffee grains, from the inside to the outside, at least sequentially includes a support layer, at least one buffer layer and a tire adhesive layer.

The coffee particles in the tire adhesive layer occupy 5% of the weight percentage of all materials of the tire adhesive layer.

Each of the coffee particles is a grain having a diameter of 0.6 mm.

The reinforcing agent is a soot crude oil.

The vulcanizing agent is sulfur.

The anti-aging agent is at least one selected from a group consisted of resin and microcrystalline wax.

Each support layer is formed by interweaving a plurality of longitudinal and a plurality of lateral cords, cotton cords, rayon cords, nylon threads, polyester cords, or metal wire cords.

More specifically, the tire having coffee grains disclosed by the present invention, under the condition of maintaining the structural strength unaffected, eliminates the odor of the tire adhesive layer using the coffee particles having multiple micro gaps and mainly consisted of a hydrocarbon, using more aggressive and reliable means, alleviates the odor of conventional tires and the resultant discomfort as well as possible toxic reactions. Further, the present invention covers repugnant odor by the natural scent of the coffee grains, and enhances added values of a product by the elegant coffee aroma of the coffee grains permanently emits.

### BRIEF DESCRIPTION OF THE DRAWINGS

FIG. 1 is a structural section view of a tire having coffee grains of the present invention; and

FIG. 2 is a structural section view of a coffee grain of the present invention.

### DETAILED DESCRIPTION OF THE PREFERRED EMBODIMENTS

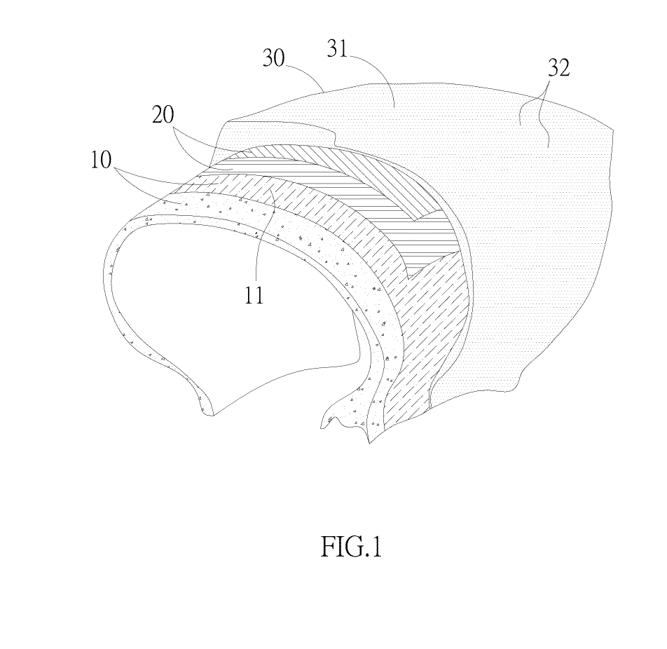

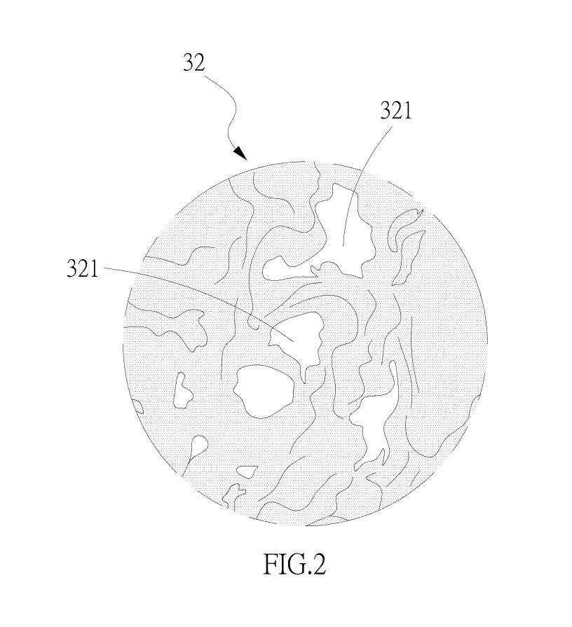

The present invention provides a tire having coffee grains capable of eliminating odor of a tire adhesive layer. As shown in FIG. 1 and FIG. 2, the tire having coffee grains of the present invention at least includes a tire adhesive layer 30. In the embodiment, an overall tire having coffee grains, from the inside to the outside, sequentially includes at least one support layer 10, at least one buffer layer 20 and a tire adhesive layer 30.

Each support layer 10 may be formed by interweaving a plurality of longitudinal and a plurality of lateral cords 11. Each buffer layer 20 may be located between the support layer 10 and the tire adhesive layer 30, and may be a plastic film with or without cords. The buffer layer 20 primarily serves a purpose of absorbing the impact transmitted from the direction of a tire tread, so as to reduce damage of the support layer and shear stress produced by a traveling tire or by a tire suddenly coming to a halt due to inertia.

One focus of the present invention is that, the tire adhesive layer 30 is at least formed by mixing and hardening components of raw rubber, a reinforcing agent, a vulcanizing agent, an anti-aging agent and a plurality of coffee grains.

Raw rubber 31 is a solid-state high polymer, and has a weight percentage between 35% and 60%. A reinforcing agent 33 is a soot crude oil, and has a weight percentage between 25% and 50%. The soot crude oil is primarily heated and burned to form solid-state carbon grains for enhancing the strength of raw rubber and to increase wear resistance. A vulcanizing agent 34 is in principle sulfur, has a weight percentage between 0.5% and 3%, and mainly serves for converting the raw material to an elastomer. An anti-aging agent 35 may be at least one selected from a group consisted of resin and microcrystalline wax, has a weight percentage between 1% and 5%, and is mainly for preventing the raw rubber material from aging and cracking caused by heat, ozone or ultraviolet radiation.

Coffee particles 32 are mainly used as a filler agent, and have a weight percentage between 1% and 10%. Preferably, the coffee particles 32 have a weight percentage between 1% and 5%. Each of the coffee particles 32 is a grain having a diameter between 0.5 mm and 1.0 mm to provide a product of the raw rubber with a deodorizing effect. The overall coffee particles 32 in the tire adhesive layer 30 occupies 5% weight percentage of all the materials of the tire adhesive layer 30, so as to achieve an optimum deodorizing effect without affecting the performance of the tire. Further, under the condition of the grain of each coffee particle 32 being a diameter of being 0.6 mm, a larger total surface area can be obtained to further yield optimum odor absorption.

In practice, under operating conditions of an environmental pressure of 19 Kg to 21 Kg, and a heating temperature of 170° C. to 183° C. for a heating period of 10 to 13 minutes, the raw rubber, the reinforcing agent, the vulcanizing agent, the anti-aging agent and the plurality of coffee particles are mixed and hardened to form the tire adhesive layer 30.

More specifically, the tire having coffee grains of the present invention, under the condition of maintaining the structural strength unaffected, eliminate the odor of the tire adhesive layer 30 using the coffee particles 32 having multiple micro gaps 321 and mainly consisted of a hydrocarbon. Therefore, the present invention using more aggressive and reliable means, alleviates the odor of conventional tires and the resultant discomfort as well as possible toxic reactions.

As shown in Table-1, proven by actual experimental tests, with structural configuration where the overall coffee particles in the tire adhesive layer occupy 2% weight percentage of all the raw materials of the tire adhesive layer, the tire having coffee grains of the present invention is capable of significantly reducing the thick smell, the pungent smell and the odor of the tire adhesive layer. More particularly, in structural configuration where the overall coffee particles in the tire adhesive layer occupy 5% weight percentage of all the raw materials of the tire adhesive layer, the effect of reducing the thick smell, the pungent smell and the odor of the tire adhesive layer can be especially accentuated.

TABLE 1
Sense experimental data of smell indices tested for tire having
coffee grains of present invention

| | Sense of smell | | | |
|---|---|---|---|---|
| | Thickness | Pungency | | Overall |
| | of smell | of smell | Odor | rating |
| Without coffee particles | 7.12 | 6.89 | 6.43 | 6.813 |
| With 2% coffee particles | 5.21 | 6.18 | 5.01 | 5.46 |
| With 5% coffee particles | 4.33 | 4.02 | 3.98 | 4.11 |

Further, upon implementing the tire having coffee grains of the present invention, the support layer is formed by interweaving a plurality of longitudinal and a plurality of lateral cotton cords, rayon cords, nylon threads, polyester cords or metal wire cords. Further, the tire having coffee grains of the present invention, from the inside to the outside, at least sequentially includes at least one support layer, at least one buffer layer and a tire adhesive layer. The tire adhesive layer is a solid-state colloid formed by raw rubber, the solid-state colloid is disposed with a plurality of coffee particles, and each of the coffee particles is a structure having multiple micro gaps.

Compared to the prior art, the tire having coffee grains disclosed by the present invention, under the condition of maintaining the structural strength unaffected, eliminates the odor of the tire adhesive layer using the coffee particles having multiple micro gaps and mainly consisted of a hydrocarbon, using more aggressive and reliable means, alleviates the odor of conventional tires and the resultant discomfort as well as possible toxic reactions. Further, the present invention covers repugnant odor by the natural scent of the coffee grains, and enhances added values of a product by the elegant coffee aroma of the coffee grains permanently emits.

In conclusion, a preferred tire having coffee grains is provided by the present invention as disclosed. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tire having coffee grains, at least comprising a solid-state tire adhesive layer, the tire adhesive layer at least being formed by mixing and hardening components of:
raw rubber, having a weight percentage between 35% and 60%;
a reinforcing agent, having a weight percentage between 25% and 50%;
a vulcanizing agent, having a weight percentage between 0.5% and 3%;
an anti-aging agent, having a weight percentage between 1% and 5%; and
a plurality of coffee particles, each of the coffee particles being a grain having a diameter between 0.5 mm and 1.0 mm, a weight percentage of all of the coffee particles being between 1% and 10%.

2. The tire having coffee grains according to claim 1, from the inside to the outside, at least sequentially comprising at least one support layer, at least one buffer layer and the tire adhesive layer.

3. The tire having coffee grains according to claim 1, wherein the coffee particles in the tire adhesive layer occupy 5% weight percentage of all materials of the tire adhesive layer.

4. The tire having coffee grains according to claim 1, wherein each of the coffee particles is a grain having a diameter of 0.6 mm.

5. The tire having coffee grains according to claim 1, wherein the reinforcing agent is a soot crude oil.

6. The tire having coffee grains according to claim 1, wherein the vulcanizing agent is sulfur.

7. The tire having coffee grains according to claim 1, wherein the anti-aging agent is at least one selected from a group consisted of resin and microcrystalline wax.

8. The tire having coffee grains according to claim 1, wherein the weight percentage of all of the coffee particles is between 1% and 5%.

9. The tire having coffee grains according to claim 2, wherein each support layer is formed by interweaving a plurality of longitudinal and a plurality of lateral cords, cotton cords, rayon cords, nylon threads, polyester cords or metal wire cords.

10. The tire having coffee grains according to claim 1, wherein the tire adhesive layer is formed by mixing and hardening under operating conditions of an environment having a pressure of 19 Kg to 21 Kg, and a heating temperature of 170° C. to 183° C. for a heating period of 10 to 13 minutes.

11. The tire having coffee grains according to claim 10, from the inside to the outside, at least sequentially comprising at least one support layer, at least one buffer layer and the tire adhesive layer.

12. The tire having coffee grains according to claim 10, wherein the coffee particles in the tire adhesive layer occupy 5% weight percentage of all materials of the tire adhesive layer.

13. The tire having coffee grains according to claim 10, wherein each of the coffee particles is a grain having a diameter of 0.6 mm.

14. The tire having coffee grains according to claim 10, wherein the reinforcing agent is a soot crude oil.

15. The tire having coffee grains according to claim 10, wherein the vulcanizing agent is sulfur.

16. The tire having coffee grains according to claim 10, wherein the anti-aging agent is at least one selected from a group consisted of resin and microcrystalline wax.

17. The tire having coffee grains according to claim 10, wherein the weight percentage of all of the coffee particles is between 1% and 5%.

18. The tire having coffee grains according to claim 11, wherein each support layer is formed by interweaving a plurality of longitudinal and a plurality of lateral cords, cotton cords, rayon cords, nylon threads, polyester cords or metal wire cords.

19. A tire having coffee grains, from the inside to the outside, at least sequentially comprising at least one support layer, at least one buffer layer and a tire adhesive layer; wherein, the tire adhesive layer is a solid-state colloid at least formed by raw rubber, the solid-state colloid is disposed with a plurality of coffee particles, and each of the coffee particles is a structure having multiple micro gaps.
